(19) United States
(12) Patent Application Publication
(10) Pub. No.: US 2013/0291637 A1
(43) Pub. Date: Nov. 7, 2013

(54) System and Method For Monitoring Mechanically Coupled Structures

(71) Applicants: Georg Dorner, Bad Krozingen (DE); Andreas Rasch, Merzhausen (DE); Heiner Igel, Windach (DE); Ulrich Schreiber, Miltach (DE); Joachim Wassermann, Munich (DE)

(72) Inventors: Georg Dorner, Bad Krozingen (DE); Andreas Rasch, Merzhausen (DE); Heiner Igel, Windach (DE); Ulrich Schreiber, Miltach (DE); Joachim Wassermann, Munich (DE)

(21) Appl. No.: 13/990,794

(22) PCT Filed: Dec. 5, 2011
(86) PCT No.: PCT/EP2011/006086

§ 371 Date: Jul. 15, 2013

(30) Foreign Application Priority Data
Dec. 6, 2010 (DE) 10 2010 053 582.6

(51) Int. Cl. G01C 19/38

(52) U.S. Cl. CPC G01C 19/38
USPC 73/504.08

(57) ABSTRACT

A system for monitoring a mechanically coupled structure with a first sensor configured to determine at predetermined times its orientation relative to Earth's rotation axis as a first measurement. The first sensor is connectable with a first part of the mechanically coupled structure with at least one second sensor which has a known first orientation to the first sensor at startup of the system and which is configured to determine a rotation rate or an acceleration as a second measurement. The at least one second sensor is connectable with a second part of the mechanically coupled structure with a central unit and with a communication network over which the central unit is connected with the first sensor and the second sensor wherein the first sensor is configured to transmit the first measurement to the central unit. The second sensor is configured to transmit the second measurement to the central unit and the central unit is configured to monitor the mechanically coupled structure by means of the first and second measurement.

### BACKGROUND

1. Field of the Invention

The present invention is directed to systems and methods for monitoring mechanically coupled structures.

2. Description of the Prior Art

Sensors are known (e.g. those based on the Sagnac effect) that determine rotations absolutely and are therefore usable for recording the dynamic behavior of large mechanically coupled structures under the influence of external forces independent of local reference frames. However, due to unavoidable drift in these sensors, frequency range is limited (from below).

### SUMMARY AND OBJECTS OF THE INVENTION

It is therefore a goal of the invention to provide a system and method for monitoring mechanically coupled structures that makes monitoring of chronological sequences of mechanically coupled structure behavior possible.

The preceding and other shortcomings of the prior art are addressed by the present invention that provides, in a first aspect, a system for monitoring a mechanically coupled structure.

A first sensor is configured to determine at predetermined times its orientation relative to Earth's rotation axis as a first measurement, wherein the first sensor is connectable with a first part of the mechanically coupled structure. At least one second sensor, which has a known first orientation to the first sensor at startup of the system and which is configured to determine a rotation rate or an acceleration as a second measurement, wherein the at least one second sensor is connectable with a second part of the mechanically coupled structure. A central unit is provided as well as a communication network over which the central unit is connected with the first sensor and the second sensor.

The first sensor is configured to transmit the first measurement to the central unit, the second sensor is configured to transmit the second measurement to the central unit and the central unit is configured to monitor the mechanically coupled structure by means of the first and second measurement.

In a second aspect the invention provides a method for monitoring of mechanically coupled structures.

Such method includes the step of determining at predetermined times the orientation of a first sensor relative to the Earth's rotation axis by means of the sensor as a first measurement. The first measurement is transmitted to a central unit. A rotation rate or acceleration of at least one second sensor, which has a known first orientation to the first sensor, is determined at startup as a second measurement. The second measurement is transmitted to the central unit. A monitoring value is generated from the first and the second measurement.

The foregoing and additional features of the invention will become further apparent from the detailed description that follows. Such description is accompanied by a set of drawing figures in which numerals, corresponding to those of the written description, point to the features of the invention. Like numerals refer to like features of the invention throughout both the drawing figures and the written description.

### BRIEF DESCRIPTION OF THE DRAWINGS

FIG. 1 is a schematic illustration of a system during monitoring of a mechanically coupled structure according to an embodiment of the invention;

FIG. 2 is a schematic illustration for determining the orientation of the sensor relative to Earth's rotation axis;

FIG. 3 is a flow diagram of a method according to a further embodiment of the invention;

FIG. 4 is a system for monitoring according to another embodiment of the invention;

FIG. 5 is a schematic structure of a system according to another embodiment of the invention;

FIG. 6 is a schematic structure of a system according to another embodiment of the invention;

FIG. 7 is a schematic structure of a system according to another embodiment of the invention; and

FIG. 8 is a schematic flow of a method according to another embodiment of the invention.

### DETAILED DESCRIPTION OF THE PREFERRED EMBODIMENT

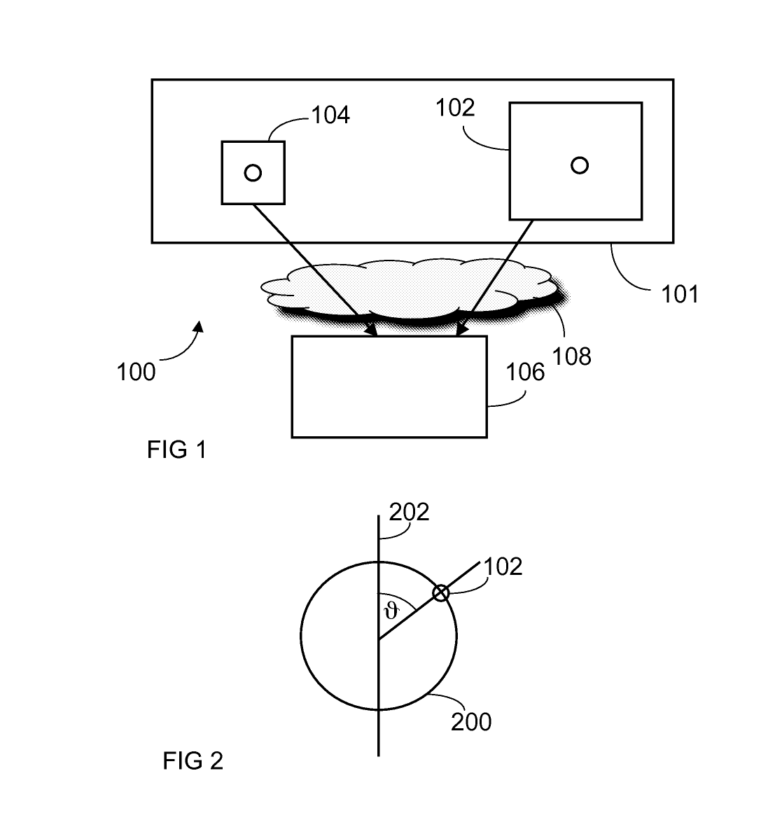

In FIG. 1 a system 100 for monitoring a mechanically coupled structure 101 is illustrated that includes a first sensor 102, configured to determine its orientation relative to Earth's rotation axis at predetermined times as a first measurement. The first sensor 102 is connectable with a first part of the mechanically coupled structure. At least one second sensor 104 is provided, which has a known first orientation to the first sensor 102 at startup of the system 100 and is configured to determine a rotation rate and/or an acceleration as a second measurement. At the same time, the at least one second sensor 104 is connectable with one second part of the mechanically coupled structure. A central unit 106 is provided as well as a communication network 108 over which the central unit 106 is connected to the first sensor 102 and the second sensor 104. The first sensor 102 is thereby configured so that the first measurements are transmitted to the central unit 106 and the second sensor 104 is configured so that the second measurements are transmitted to the central unit 106. The central unit 106 is configured to monitor the mechanically coupled structure 101 by means of the first and the second measurements.

The first sensor 102 may be formed, for example, as a Sagnac sensor or a Coriolis sensor. Both types of sensors are able to detect their orientation relative to Earth's rotation axis via the Sagnac effect and the Coriolis effect, respectively.

The communication network 108 may be wireless or wire-bound. Optical communication via optical fiber cables or via free space propagation is possible as well as electric or electromagnetic communication. In this process, any communication paths between the sensors 102, 104 and the central unit 106 are possible. For example, a direct unidirectional communication between the single sensors 102, 104, respectively, and the central unit 106 may be provided as a communication path that is particularly easy to implement. Also more complex communication paths like bidirectional communication between the single sensors 102, 104 as well as between each of the sensors 102, 104 and the central unit 106 are possible.

If necessary, the system may be improved by providing GNSS (Global Navigation Satellite System) sensors technology (not illustrated), as for example GPS (Global Positioning System), Galileo or Glonass in the sensors 102, 104, and then a measurement of the absolute position of the sensors 102, 104 is possible. Furthermore, using a fixed connection of antennas of the GNSS to the sensors 102, 104 it is possible to draw conclusions about rotations of the antennas (inclination or torsion) of the GNSS by the measurements of the sensors 102, 104, which would not be readily possible by satellite navigation alone. The antennas of the GNSS may also be used for determining translations.

In FIG. 2 it is schematically illustrated how the first sensor 102 on Earth's surface 200 is inclined by a given angle θ with respect to Earth's rotation axis 202. Long time observations on mechanically coupled structures by the system of the present invention are possible by comparing the measurements with the value of the projection of the known and constant Earth's rotation rate on the sensitive sensor axis of one of the sensors 102, 104. At the same time, the reference to Earth's rotation axis 202 provides a criterion for avoiding a measurement error (false alarm), as the measurement is always correlated to Earth's rotation rate. If this is not the case normally a measurement error has occurred.

By the fixed reference of the first sensor 102 to Earth's rotation axis 202 it is possible to filter a long time drift, which also enables long time measurements, such as the detection of landslides, settlement of buildings, etc.

The second sensor 104 may be formed as a rotation sensor, which has less precision for determining the orientation to Earth's rotation axis compared to the first sensor 102, whereby the system can be reasonably priced. The first sensor 102 may, for example, have a precision of 0.01°/hour or better, while the second sensor may have a precision of only 1°/hour.

A mechanically coupled structure 101, monitored with the system and the method of the present invention, respectively, may be a structure, for which it is important to determine whether the orientation of single parts with respect to each other is changing, for example a building, a bridge, a ship, an airplane or a machine. While it is important for the aforementioned structure to detect any movements with respect to one other reliably in order to determine damages (e.g. after an earthquake) there are also known mechanically coupled structures, whose parts are allowed to move in specific allowed directions. For example, the rotor of a wind turbine is allowed to perform a rotational movement with respect to the stator. Rotating unbalance of the rotor, which leads to an additional linear component of movement of the rotor, should, however, be detected, allowing for repair of the wind turbine if necessary. Also parts of Earth's surface (such as mountainsides, but also continuously connected parts of the earth crust) may be viewed as mechanically coupled structures.

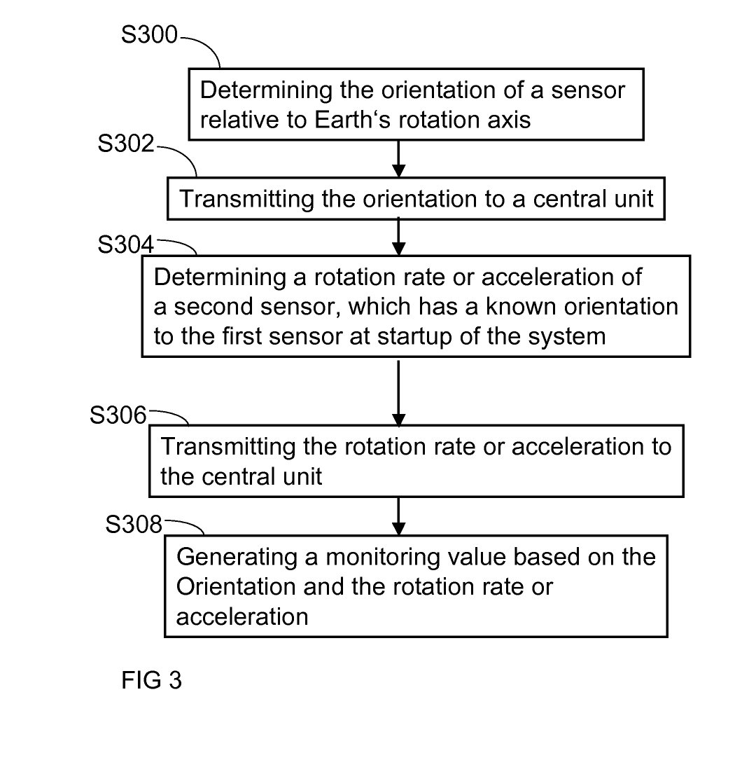

FIG. 3 is a flow diagram of a method of the present invention. In that method in a first step S300 the orientation of the first sensor 102 is determined with respect to Earth's rotation axis 202. Thereafter, the orientation is transmitted to the central unit 106 in step S302. The rotation rate or acceleration of the second sensor 104 is determined by means of the second sensor 104 in step S304, wherein at startup of the system 100 the at least one second sensor 104 has a known first orientation relative to the first sensor 102. Afterwards, the measured rotation rate or acceleration of the at least one sensor 104 is transmitted to the central unit 106 in a step S306. Thereafter, in step S308, a monitoring value is generated from the transmitted orientation of the first sensor 102 and the rotation rate or acceleration of the at least one second sensor 104, the monitoring value being used to monitor the mechanically coupled structure 101.

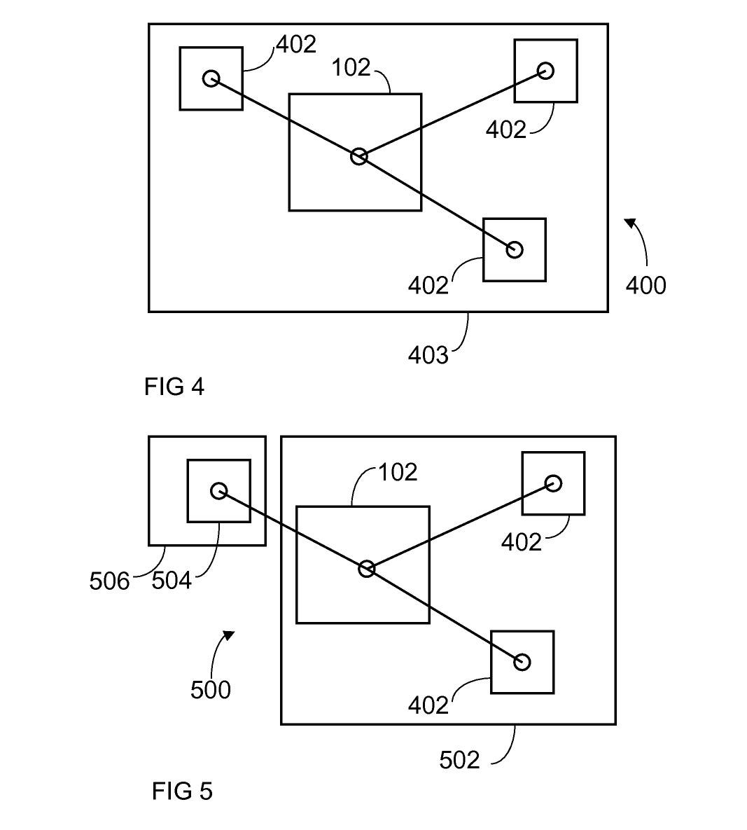

In a hybrid sensor system 400 as illustrated in FIG. 4, two or more rotation rate sensors 102, 402 can capture changes of state (e.g. deformations) of a mechanical overall structure 403 or of parts of the mechanically coupled structure relative to each other, based on the Sagnac effect, the Coriolis effect and the inertia effect with different resolutions and with their relative reference to each other. In doing so, the highly resolving first sensor 102, also called central sensor or master, provides the external reference to the earth rotation vector 202 of the earth 200 as a fixed reference, while more simple (less exact) sensors 402 or slaves capture only the local reference to the master 102 as a function of time. In doing so, the sufficient sensitivity of the slaves is used for rotation measurements. The inferior sensitivity for the orientation of the slaves relative to the position of Earth's rotation axis 202 is then irrelevant. Thus, the different characteristics of the single sensors are transferred to each other (e.g. the absolute reference of the Sagnac effect to the Coriolis effect sensor or the inertia effect sensor, respectively). The central unit 106 is not illustrated. It may be connected with one of the illustrated sensors 102, 402 for transmission of measurements, or may be, for example, housed with the first sensor 102 (or with one of the second sensors 402) in a common casing.

With such a system loads or damages on buildings can be determined over deformations, which have been caused by earthquakes for example. The deformation of the structure gives a primary measurement, is present before damage, and can be used for quantitative ad hoc judgment of the potential of damage of a load. In this concept the first sensor 102 and the several second sensors 402 are firmly connected with the basic structure of a building 403. As the first sensor 102 can capture rotations absolutely based on the Sagnac effect, the orientation of the building relative of the rotation axis 202 of the earth 200 is determined automatically, before, during and after an earthquake in real time. This allows the determination of the change of orientation of a building, which may have changed due to influences of a force, such as an earthquake or the like, without the need for local references.

According to FIG. 5, a further hybrid sensor system 500 can be formed from two or more rotation rate sensors 102, 402, 504 based on the Sagnac effect, the Coriolis effect, and the inertia effect with different resolutions and their relative reference to each other. Changes in the arrangement of parts of a totally or partly moveable mechanical overall structure or of parts 502, 506 of a totally or partly moveable mechanically coupled structure in relation to each other are thereby captured. In doing so, the highly resolving central sensor 102 (master) provides the external reference to the earth rotation axis 202 of the earth 200 as fixed reference, while the simpler sensors 402, 504 captured the local reference to the master 102 dynamically as a function of time. Thus, the measurement method is applicable as method of inertia measurement for the relative movement of different mechanically coupled structures 502, 506 (e.g. parts of machines) with moveable components relative to each other if no optical, electrical or mechanical connection can be provided between these parts. Thus, the different characteristics of the single sensors 102, 402, 504 are transferred to each other (e.g. absolute reference of the Sagnac effect to Coriolis effect sensor and inertia effect sensor). The system is therefore applicable for monitoring of non-allowed movements in a system in which parts of a mechanical structure are allowed to move with respect to each other in a predetermined range (allowed movement).

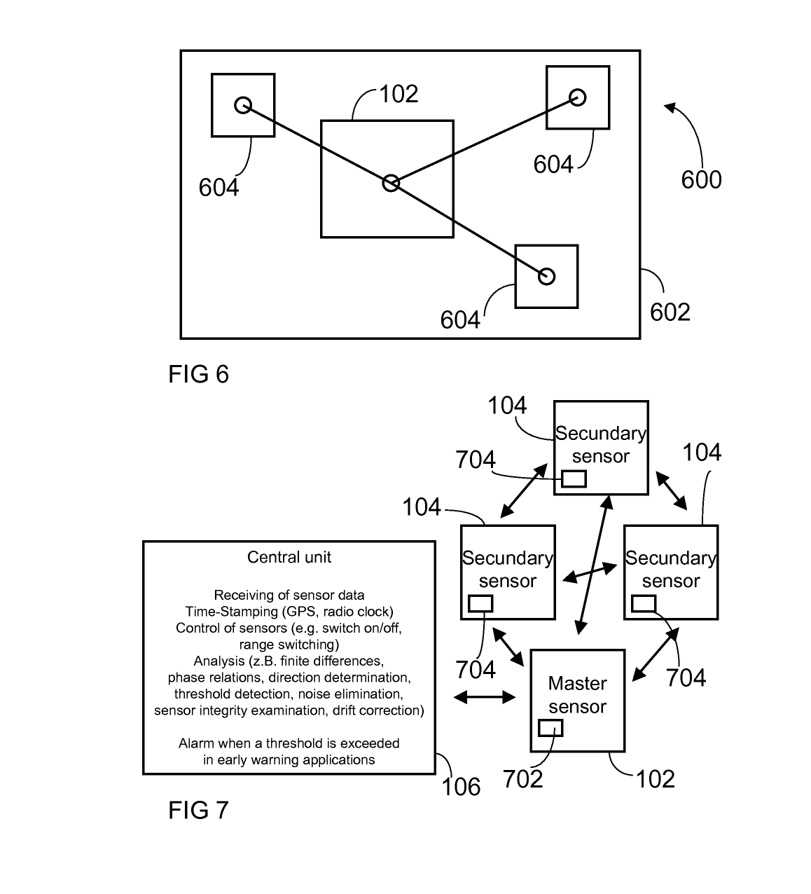

According to FIG. 6, a further hybrid sensor system 600 can be provided, which includes at least one accelerometer 604 (in FIG. 6 three of such accelerometers 604 are illustrated), wherein the sensors 102, 604 are attached together to a mechanically coupled structure or are attached on Earth's surface 602 and are therefore able to determine ground and structure characteristics, respectively (tomography, exploration). In this case the relation is employed that the measured rotation rate \dot{Ω} and the transversal acceleration a of an excitation signal (e.g. a seismic wave) are in phase in an homogeneous medium and the proportionality of these signals, captured independently of each other, correspond to the phase velocity c as shown in equation (1):

$$\dot{Ω} ( x , t ) = - \frac{a ( x , t )}{2 c} \qquad ( 1 )$$

The phase velocity c (an apparent phase velocity in a heterogeneous medium as ratio of the rotation rate \dot{Ω} and the acceleration a) is changing significantly with the ground conditions (granite has a specific phase velocity, for example) so that an exploration can be carried out by means of these systems. Hence, it is possible to search for deposits with a portable device and to analyze the time dependence by a fixedly installed network of sensors, respectively.

According to the embodiment of the system 700 illustrated in FIG. 7 the first sensor or master sensor 102 and the second or secondary sensors 104 are bidirectionally connected with each other on the basis of a self-organizing network and communicate across the network. This reduces the needed transmission power per sensor and facilitates the enlargement/reduction of the network, as no interventions of a user are necessary. In this process, the first sensor 102 is connected to the central unit 106. The central unit 106 provides important functions for data usage and interpretation such as receiving of sensor data, a determination of time (“time stamping”) (GPS, radio clock or the like), control of the sensors (e.g. switch on/off, range switching), an analysis (e.g. finite differences, phase relations, direction determination, threshold detection, noise elimination, sensor integrity examination, drift correction) and, if necessary, an alarm when a threshold is exceeded in early warning applications. At a deformation of the mechanically coupled structure 101, which is measured by the sensors 102, 104 and detected by the central unit 106, the integrity of the sensors 102, 104 can be guaranteed by a finite difference calculation and the degree of deformation can be determined.

Provided that the slave sensors have not moved from their original location/arrangement, their inertial measurements, which get less precise in the course of time, can be recalibrated. This can be carried out on the one hand by exact initial measurement of the location/arrangement and, if necessary, the positions of the sensors relative to Earth's rotation axis at the initiation of startup and by storing at a time to the averaged single measurement values, which are then newly displayed, on the other hand by comparison of the measurements after an advanced time t₁ (for example after a predetermined time interval after startup of the system, if necessary repeatingly after predetermined time intervals) with measurements of the master sensor which generates smaller measurement errors over time because of higher precision. The first method can be used for all kinds of rotation sensors, therefore also for those which, due to their limited precision, are not able to resolve earth rotation rate as measurement value reference signal themselves. The second method raises the integrity of the self-calibration method considerably, as a check of plausibility with the actual conditions in the spatial proximity of the single slave sensors is carried out via current measurements of the master sensors.

One has to take into account that, for a successful self-calibration, no event should have happened which changes the original location/arrangement of the slave sensor. This information is given in realistic cases (earthquake, abrupt change of position) mostly directly in the data of the slave sensors.

A further possibility is the self-calibration of the slave sensors, which themselves have the capability to measure Earth's rotation rate as a reference signal with sufficiently high precision. Then, the slave sensor can self-consistently initiate self-calibration against the original values of Earth's rotation rate measurement in case a tolerance threshold of the drift values is exceeded in the course of time. Also the master sensor would have to perform this procedure after a longer time period in order to maintain stable drift values over very long time periods.

At this point the comparison to current master measurements can again increase the integrity of the method considerably.

As already discussed, it is also possible that the central unit 106 is housed together with the first sensor 102 or even one of the second sensors 104 in a casing.

A time reference can be provided by using a clock as time measurement device 702, 704 at single sensors 102, 104 or also via radio communication with a guaranteed low latency time (specification of the transmission protocol), wherein the assignment of times (per clock) can be carried out at the central unit 106 for each single sensor 102, 104. The time references used are, for example, to get a chronological sequence of the processes and to bring the measurements determined at different times in relation to each other. In this way the spread of damages over time can be determined and determination of the integrity of the system can be drawn. For example, it can be assumed that, in the case of a proceeding spread of an offset of parts of a mechanically coupled structure 102, all sensors 102, 104 connected with the mechanically coupled structure 101 acquire the orientation and acceleration change, respectively, in an expected chronological sequence, that depends on the respective position of the sensors 102, 104. In case single sensors 102, 104 measure a time dependence of the orientation or acceleration, respectively, it can be assumed from differences that a measurement error has occurred.

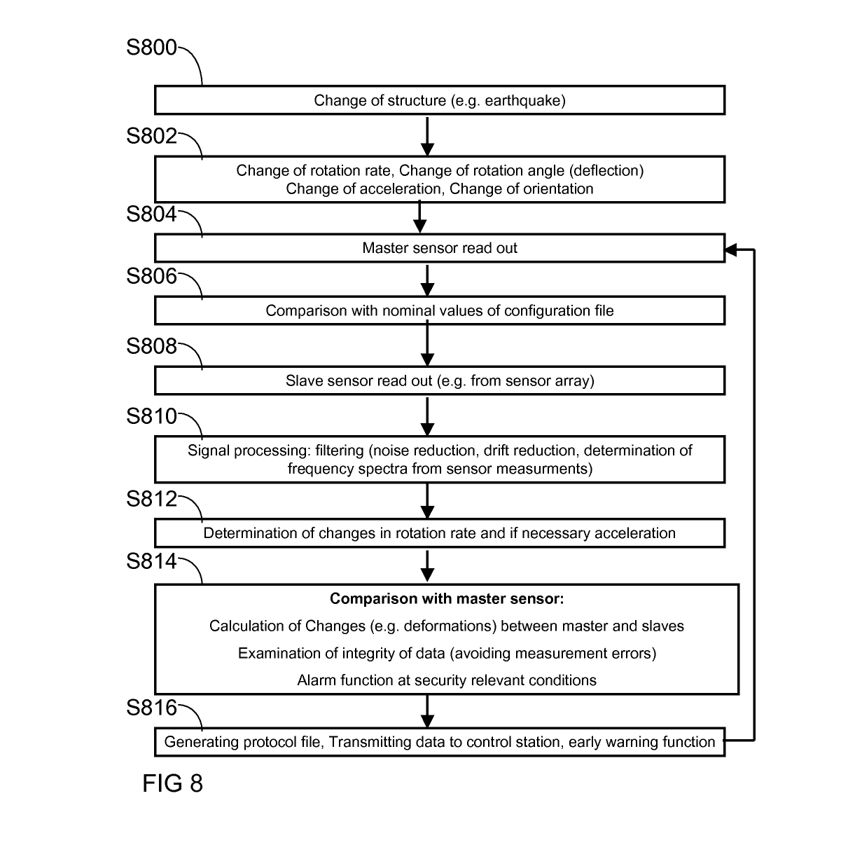

According to FIG. 8 a process is illustrated in flow diagram for which, in a step 800, a change of structure of the mechanically coupled structure 101 occurs, e.g. by an earthquake. In step 802 a change of rotation rate, a change of rotation angle (deflection), a change of acceleration or a change of orientation results which is read out in the step S804 over the first sensor 102. Afterwards, in a step S806, the comparison of the measured value with a nominal value of a configuration file is carried out. If necessary, in step S808, read out of the second sensors 104 is carried out, which are, for example, arranged in a sensor array. In step S810, a signal processing is carried out afterwards, for example a filtering or noise reduction or drift reduction, respectively. During signal processing, a determination of time-dependent frequency spectra from the chronological sequence of the transmitted first and second measurements may also be carried out. As it is possible to obtain time exact series of measurements of all first and second sensors 102, 104, all those time-dependent frequency spectra can be generated, which characterize the mechanically coupled structure. It is possible to deduce from changes in these frequency spectra changes and damages, respectively, in the mechanically coupled structures. Such functionality can serve as an early warning function.

In following step S812 changes of the rotation rate and, if necessary, an acceleration are determined. By a comparison with a master sensor 102 in a step S814, changes between the first sensor 102 and the second sensor 104 are calculated whereby, for example, deformations can be recognized. Moreover, the integrity of data is examined, in order to avoid measurement errors. In case of security relevant conditions an alarm function is initiated. In step S816 a protocol file is generated afterwards and files may be transmitted to a control station and an early warning function may be activated, respectively. Afterwards, the master sensor 102 is read out again in step S804 and the monitoring of the mechanically coupled structure 101 is carried out anew.

While the invention has been described with reference to its presently-preferred embodiment, it is not limited thereto. Rather, this invention is limited only insofar as it is defined by the following set of patent claims and includes within its scope all equivalents thereof.

1. System for monitoring a mechanically coupled structure with
a first sensor configured to determine at predetermined times its orientation relative to Earth's rotation axis as a first measurement, wherein the first sensor is connectable with a first part of the mechanically coupled structure,
at least one second sensor, which has a known first orientation to the first sensor at startup of the system and which is configured to determine a rotation rate as a second measurement,
at least one third sensor, which has a known first orientation to the first sensor at startup of the system and which is configured to determine an acceleration as a third measurement, wherein the at least one second sensor and the at least one third sensor is connectable with a second part of the mechanically coupled structure,
a central unit, and
a communication network over which the central unit is connected with the first sensor, the second sensor, and the third sensor,
wherein the first sensor is configured to transmit the first measurement to the central unit, the second sensor is configured to transmit the second measurement to the central unit, the third sensor is configured to transmit the third measurement to the central unit, and the central unit is configured to monitor the mechanically coupled structure by means of the first, second, and third measurements.

2. System according to claim 1, characterized in that
the at least one second sensor is formed as rotation sensor which has compared to the first sensor less precision for determining the orientation of Earth's rotation axis.

3. System according to claim 2, characterized in that
the first sensor and the second sensor comprise a time measurement unit and transmit the first and second measurements together with the times at which the measurements were taken to the central unit and
that the central unit is configured to determine a chronological sequence of the orientation of the first sensor and the second sensor to each other from the transmitted measurements and the transmitted times.

4. (canceled)

5. System according to claim 1, characterized in that
the first sensor and the at least one second sensor are attached at different positions to the monitored mechanically coupled structure.

6. System according to claim 1,
characterized in that
the communication network is configured for bidirectional direct communication between the sensors.

7. System according to claim 1,
characterized in that
the second sensor is configured to be recalibrated on the basis of the measurements of the first sensor after a predetermined time interval after startup of the system.

8. Method for monitoring of mechanically coupled structures comprising the following steps:
determining at predetermined times the orientation of a first sensor relative to the Earth's rotation axis by means of the sensor, wherein the first sensor is connected with a first part of the mechanically coupled structure,
transmitting the first measurement to a central unit over a communication network,
determining a rotation rate of at least one second sensor, which has a known first orientation to the first sensor at startup of the system as a second measurement,
determining of the acceleration of at least one third sensor, which has a known first orientation to the first sensor at startup of the system as a third measurement, wherein the at least one second sensor at the at least one third sensor are connected with a second part of the mechanically coupled structure,
transmitting of the second and the third measurement to the central unit over the communication network,
generating a monitoring value from the first, the second, and the third measurement.

9. Method according to claim 8,
characterized in that
the second sensor measures his change of orientation independently from the transmitted orientation of the first sensor and a change of the position of the second sensor with respect to the position of the first sensor is determined by means of the transmitted orientation of the first sensor.

10. Method according to claim 8,
characterized in that
the first sensor and the second sensor are each attached at different parts of a mechanically coupled structure, wherein the different parts are unmoveably mechanically coupled with respect to each other.

11. Method according to claim 8,
characterized in that
the first sensor and the second sensor are each attached at different parts of a mechanically coupled structure, wherein the different parts are moveably mechanically coupled with respect to each other,
the respective different parts can perform movement with respect to each other allowed by the mechanical coupling, and
the monitoring value determined from the central unit indicates whether one of the allowed or non-allowed movements between the different parts is present.

12. Method according to claim 8,
characterized in that
vibration excitations are impressed from outside on the mechanically coupled structure,
the third sensor is formed as translation sensor and the apparent phase velocity of the measured vibration in the mechanically coupled structure is determined from the measured orientation of the first sensor or of the second sensor and the measured acceleration of the translation sensor.

13. Method according to claim 8,
characterized in that
the central unit detects a measuring error in case the measurement of the first sensor does not contain Earth's rotation rate.

14. Method according to claim 8, characterized in that
the central unit determines time-dependent frequency spectra from a chronological sequence of the transmitted first measurements, and the transmitted third measurements and generates a further monitoring value from the frequency spectra.

15. Method according to claim 8,
characterized in that
the second sensor and/or the third sensor is recalibrated after a predetermined time interval after the startup of the system.

16. Method according to claim 8, characterized in that
the mechanically coupled structure is formed as an antenna of a Global Navigation Satellite System GNSS.
